(19) United States
(12) Patent Application Publication
(10) Pub. No.: US 2006/0285905 A1
(43) Pub. Date: Dec. 21, 2006

(54) Image forming apparatus and method having both-sides printing function

(75) Inventor: Hyun-kyoung Choung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/439,948

(22) Filed: May 25, 2006

(30) Foreign Application Priority Data
Jun. 16, 2005 (KR) 2005-52080

(51) Int. Cl. G03G 15/00

(52) U.S. Cl. 399/401

(57) ABSTRACT

An image forming apparatus includes: a main body including a paper-feeding unit supplying paper, an image forming unit forming an image on the paper from the paper-feeding unit, and a paper-ejecting unit ejecting the paper from the image forming unit; and a paper-feeder cartridge detachably mounted on the main body and supplying the paper loaded in the paper-feeding unit, wherein the main body includes a first guide clutch provided in an exit side of the image forming unit and converting a path of the paper passed through the image forming unit, and a return-path conveying the paper path-converted through the first guide clutch, and the paper-feeder cartridge including a return-paper inlet to introduce the paper conveyed through the return-path to a reversing unit reversing the paper introduced through the return-paper inlet, and a return-paper exit conveying the paper reversed through the reversing unit to the paper-feeding unit.

### CROSS-REFERENCE TO RELATED APPLICATIONS

This application claims the benefit of Korean Patent Application No. 2005-52080, filed Jun. 16, 2005, in the Korean Intellectual Property Office, the disclosure of which is incorporated herein by reference.

### BACKGROUND OF THE INVENTION

1. Field of the Invention

Aspects of the invention relate to an image forming apparatus and method, and more particularly, to an image forming method and apparatus having a both-sides printing function.

2. Description of the Related Art

As shown in FIG. 1, a conventional image forming apparatus, for example, a laser beam printer. The apparatus includes a main body 100 having a paper feeder 110 to feed paper, an image forming unit 120 forming a toner image on the paper conveyed from the paper feeder 110, and a paper ejector 130 ejecting the paper conveyed from the image forming unit 120. First and second cartridges 150 and 160 are detachably mounted in the main body 100 in order to supply paper to the paper feeder 110. The first cartridge 150 and the second cartridge 160 are vertically stacked one above another and supply loaded paper one by one automatically or according to a user selection.

In the apparatus of FIG. 1, the paper supplied to the paper feeder 110 from the first cartridge 150 or the second cartridge is introduced into the image forming unit 120 through a paper-feeding path 101. The image forming unit 120 forms an electrostatic latent image on the paper through light-radiation from an optical unit 121. Toner is transferred onto the paper having the electrostatic latent image formed thereon. The paper, where toner is transferred, is conveyed to a fixing unit 122, in which the toner is fixed on the paper. After fixing the toner, the paper is ejected to the outside through the paper ejector 130. With such a conventional image forming apparatus, an image is formed only on one side of the paper, while the paper travels from the paper feeder 110 to the paper ejector via the image forming unit 120.

Further, various types of image forming apparatuses capable of both-sides printing have been developed. For example, Korean Patent Application No. 2001-8242, filed on Feb. 19, 2001, discloses an image forming apparatus capable of both-sides printing. Also, Korean Patent Application No. 2003-47536, filed on Jul. 12, 2003, discloses a both-sides printer. Additionally, Korean Patent Application No. 2003-80524, filed on Nov. 14, 2003, discloses an apparatus to prevent skew in an image forming apparatus capable of both-sides printing.

In the above related art, however, a separate space typically needs to be provided inside the main body of an image forming apparatus in order to achieve both-sides printing, so that the apparatus can become bulky. In addition, due to additional components required for the both-sides printing, the cost can be significantly increased, as compared with one-side printing apparatuses.

### SUMMARY OF THE INVENTION

Accordingly, it is an aspect, among other aspects, of the invention to provide an image forming apparatus, in which existing components of an image forming apparatus can be modified to achieve a both-sides printing function, without providing a separate element for the both-sides printing to the main body thereof, thereby promoting and improvement in efficiency in terms of space and cost.

The foregoing and/or other aspects of the present invention can be achieved by providing an image forming apparatus including: a main body, the main body including a paper-feeding unit supplying paper, an image forming unit forming an image on the paper supplied from the paper-feeding unit, and a paper-ejecting unit ejecting to the outside the paper passed through the image forming unit; and a paper-feeder cartridge detachably mounted on the main body and supplying the paper loaded in the paper-feeding unit, wherein the main body further includes a first guide clutch provided in an exit side of the image forming unit and converting a path of the paper passed through the image forming unit, and a return-path conveying the paper path-converted through the first guide clutch, and the paper-feeder cartridge further includes a return-paper inlet through which the paper conveyed through the return-path is introduced, a reversing unit to reverse the paper introduced through the return-paper inlet, and a return-paper exit to convey the paper reversed through the reversing unit to the paper-feeding unit.

According to a further aspect of the invention, the reversing unit includes an accommodation path accommodating the paper introduced through the return-paper inlet; a reversing path, one end of which is connected with the accommodation path and the other end of which is connected to the paper-feeding unit; and a conveyor roller conveying the paper accommodated in the accommodation path to the paper-feeding unit through the reversing path.

According to another aspect of the invention, the reversing unit further includes a first sensor to sense the paper being introduced into the return-paper inlet; a second sensor to sense the paper accommodated in the accommodation path; and a second guide clutch to block a position between the accommodation path and the reversing path based on a signal from the first sensor and to block a position between the return-paper inlet and the accommodation path based on a signal from the second sensor.

According to yet a further aspect of the present invention, the apparatus further includes an upper cartridge and a lower cartridge selectively detachably mounted up and down in the main body, wherein the paper-feeder cartridge includes the lower cartridge.

While the invention is described in terms of an image forming apparatus and methods for paper copying, the invention, and aspects thereof, also applies to other types of media that can be suitable for both-sides printing, such as film type media, or other suitable type media for image forming, in addition to paper type media, in practice and applications of the invention. As such, references herein to paper also can correspond to other suitable medium or media, and the references to image forming apparatus can also apply to corresponding image forming apparatus for both-sides printing for other suitable media.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view showing a conventional image forming apparatus.

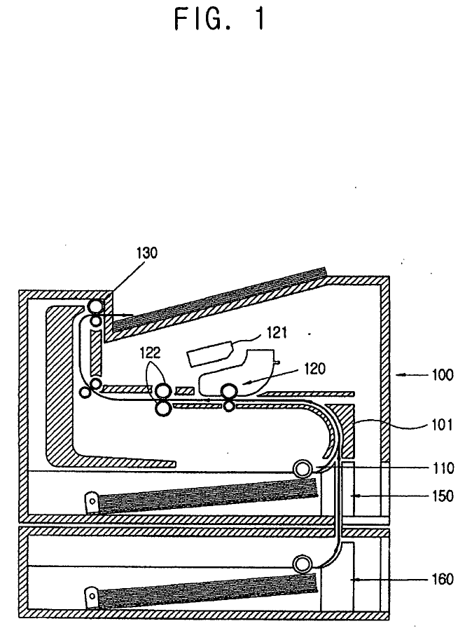

FIG. 2 is a sectional view illustrating an image forming apparatus according to an embodiment of the present invention.

FIG. 3 is a block diagram explaining the operation control of the image forming apparatus of FIG. 2.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures.

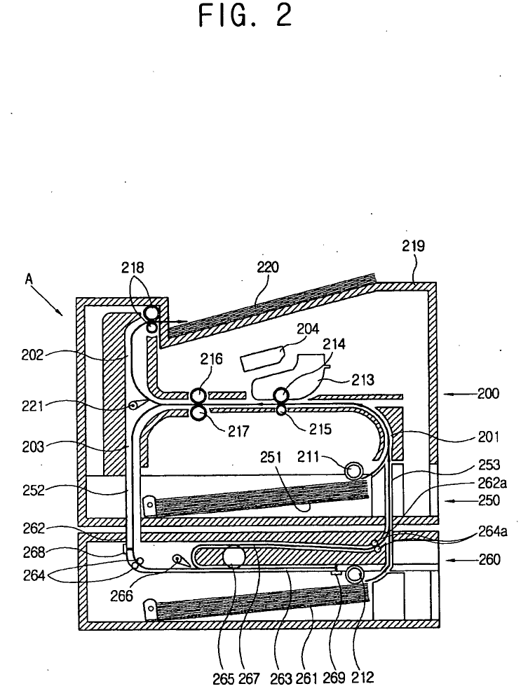

FIG. 2 is a sectional view showing an image forming apparatus A according to an embodiment of the invention. As shown in FIG. 2, the image forming apparatus A includes a main body 200, an upper cartridge 250 and a lower cartridge and lower cartridge 260, which are detachably mounted under the main body 200. The main body 200 of the image forming apparatus A is provided with a paper-feeding unit for supplying paper, i.e., pick-up rollers 211 and 212 for picking up paper from the upper cartridge 250 and the lower cartridge 260 and conveying the paper to the paper path. Alternatively, the upper and/or the lower cartridges 250 and 260 can also include all or part of the paper-feeding unit, such as the pick-up rollers 211 and 212. The pick-up rollers 211 and 212 pick up and supply the paper one by one from the top paper loaded in knock-up plates 251 and 261 of the upper and lower cartridges 250 and 260. The paper supplied by the pick-up roller 211 is conveyed to a developer 213 through a paper-feeding path 201 and a predetermined conveyor roller (not shown).

Continuing with reference to FIG. 2, on the surface of a photosensitive drum 214 of the developer 213, a latent image is formed by a laser light radiated from an optical unit 204. A toner is transferred from a developing roller (not shown) provided in the developer 213 to thereby develop an image. The image developed on the surface of the photosensitive drum 214 is transferred onto the paper while passing between the developer 213 and the photosensitive drum 214. Then, the paper is heated and pressed by a heating roller 216 and a pressing roller 217 while passing through a fixing unit 216, 217, so that the image is fixed on the paper. Thus, the image forming unit to form an image on the paper supplied through the paper-feeding unit includes the developer 213, the transfer roller 215, the optical unit 204, and the fixing unit 216, 217. After passing through the fixing unit 216, 217, the paper is loaded, to pass through a paper-ejecting path 202 to a paper ejecting unit, i.e., a paper-ejecting roller 218, on a paper-stacking unit 220 provided on the top face of a casing 219. The paper ejecting unit ejects the paper to the outside of the main body 200 of the image forming apparatus A, when image forming on the paper is completed.

On the other hand, in the main body 200 of the image forming apparatus A, a return path 203 is formed in the vertical opposite side to the paper-ejecting path 202 and connected to the fixing unit 216, 217 in symmetrical relationship with the paper-ejecting path 202. In addition, a first guide clutch 221 is installed, or provided, adjacent to an exit side of the image forming unit, at the meeting point of the paper-ejecting path 202 and the return path 203. The paper passing through the fixing unit 216, 217 is guided by the first guide clutch 221 into the paper-ejecting path 202 or the return path 203. That is, in a case where both-sides, or duplex, printing on the paper is selected, the first guide clutch 221 is pivoted counterclockwise to block the inlet of the paper-ejecting path 202, so that the paper passing through the fixing unit 216, 217 can be guided into the return-path 203. Conversely, in a case of one-side, or simplex, printing on the paper, the first guide clutch 221 is pivoted clockwise to thereby block the inlet of the return-path 203, so that the paper is conveyed through the paper-ejecting path 202.

When both-sides printing is performed in the image forming apparatus A of FIG. 2, the paper passed through the fixing unit 216, 217 is introduced into the return-path 203. The return-path 203 is extended to a return-paper inlet 262 of the lower cartridge 260. Thus, the region of the main body 200 and the upper cartridge 250 is provided with a through-path 252 formed in vertical direction to form the return-path 203. The return-paper inlet 262 is formed in the lower cartridge 260, and the paper, returning through the return-path 203 formed in the main body 200, is introduced into a reversing unit in the lower cartridge 260 through the return-paper inlet 262, the reversing unit reversing a position of the sides of the paper when image forming on one side of the paper has been completed so that image forming can then be competed on the other side of the paper.

Also, in the image forming apparatus A, the lower cartridge 260 includes the reversing unit that includes an accommodation path 263, which accommodates paper introduced through the return-path 203 to the return-paper inlet 262, and a plurality of conveyor rollers 264 and 265 to convey the paper so as to be accommodated in the accommodation path 263. Further, the conveyor roller 265 is configured to selectively rotate counterclockwise so that the paper can be completely accommodated in the accommodation path 263.

Continuing with reference to FIG. 2, similarly to the first guide clutch 221 installed in the main body 200, the reversing unit also includes a second guide clutch 266 installed in the lower cartridge 260. Thus, when the paper is introduced through the return-paper inlet 262, the second guide clutch 266 is selectively pivoted counterclockwise to a position so that the return-paper inlet 262 of the return unit is communicated with the accommodation path 263. Then, when the paper is completely received in the accommodation path 263, the second guide clutch 266 is selectively turned, or rotated, clockwise to a position to thereby block the return-paper inlet 262 from communicating with the accommodation path 263.

Further, in the image forming apparatus A, after the paper is completely accommodated in the accommodation path 263, the conveyor roller 265 is selectively reversely rotated i.e., counterclockwise so that the paper can be conveyed back again from the accommodation path 263 and the paper is then introduced into a reversing path 267 of the reversing unit, which is extended from the inlet of the accommodation path 263 and is typically placed above the accommodation path 263. The reversing path 267 is formed so that one end of the reversing path 267 is connected with the inlet of the accommodation path 263 and the other end of the reversing path 267 is connected with a return-paper exit 262a through which the paper from the reversing path 267 of the reversing unit is conveyed, such as through rollers 264a to the paper-feeding path 201 of the main body 200, when the position of the sides of the paper has been reversed by the paper passing through the reversing path 267. Also, in order to complete the reversing path 267, a through-path 253, as a part of the paper-feeding path 201 can be formed in a corresponding region of the upper cartridge 250.

Therefore, in the image forming apparatus A, the top and bottom sides of the paper, when an image is formed on one side of the paper, are reversed in position while passing through the accommodation path 263 and the reversing path 267, so that both-sides printing on the paper can be performed. Thereafter, another image is formed on the reversed paper, i.e., on the other side of the paper, while again passing through the paper-feeding path 201 of the main body 200. The paper, when images are formed on both sides thereof, then passes through the fixing unit 216, 217. At this time, the first guide clutch 221 is selectively pivoted clockwise to thereby block the return-path 203 so that the paper can be loaded on the paper-stacking unit 220 typically located outside of the main body 200 via the paper-ejecting path 202 and the paper-ejecting roller 218.

In the image forming apparatus A, as previously mentioned, the lower cartridge 260, the accommodation path 263, the reversing path 267 and the conveyor roller 265 constitute a reversing unit to reverse the paper introduced into the cartridge. Further, for a complete operation of the reversing unit, the reversing unit in the lower cartridge 260 also includes a first sensor 268 provided in the return-paper inlet 262 side and a second sensor 269 provided at the end of the accommodation path 263.

Accordingly, in the image forming apparatus A, the second guide clutch 266 and the conveyor roller 265 are configured to be selectively operated according to sensing signals from the first sensor 268 and the second sensor 269. Therefore, when paper is introduced into the return-paper inlet 262, the first sensor 268 detects the paper and thus the second guide clutch 266 is selectively turned counterclockwise according to the sensing signal from the first sensor 268 to selectively block a position between the accommodation path 263 and the reversing path 267. Thus, the return-paper inlet 262 is communicated with the accommodation path 263, and the reversing path 267 is blocked from the accommodation path 263, thereby accommodating the paper in the accommodation path 263. At this time, the conveyor roller 265 is selectively rotated counterclockwise to thereby convey the paper into the accommodation path 263.

On the other hand, in the image forming apparatus A, when the paper is completely received in the accommodation path 263, the second guide clutch 266 is selectively turned, or rotated, clockwise according to a sensing signal of the second sensor 269 to thereby selectively block a position between the return-paper inlet 262 and the accommodation path 263. In addition, the conveyor roller 265 then selectively rotates clockwise so that the paper is introduced into the reversing path 267.

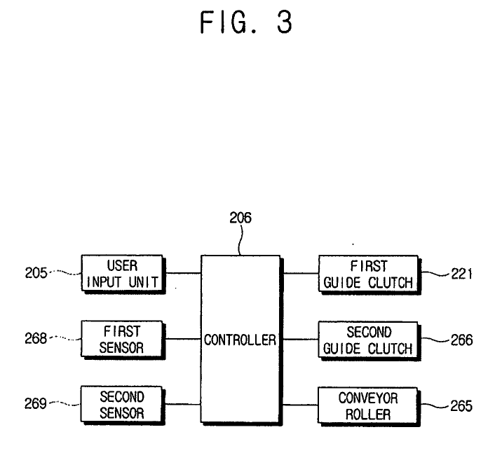

FIG. 3 is a block diagram explaining the operation control of the image forming apparatus A of FIG. 2 according to an embodiment of the invention. Referring to FIGS. 2 and 3, first, in order to reverse paper passing through the fixing unit 216, 217, the first guide clutch 221 is selectively controlled by a controller 206, such as a processor, microprocessor or an application specific integrated circuit (ASIC), with associated memory and software or programming, to control the operation of the image forming apparatus A, according to a selection input, such as through a user input unit 205 provided in the main body 200. When one-side printing is selected through the user input unit 205, the first guide clutch 221 selectively remains, or is selectively positioned, in a position to block the return-path 203. On the other hand, when both-sides printing is selected through the user input unit 205, the first guide clutch 221 is selectively turned to a position to permit the paper to be guided into the return-path 203 to the reversing unit so that the position of the sides of the paper can be reversed so that printing can then occur on the other of the two sides of the paper. In this regard, when the paper has undergone one-side printing through the developer 213 and the fixing unit 216, 217, the paper is guided into the return path 203. The paper, which is guided through the return-path 203 to and through the reversing unit in the lower cartridge 260, is then fed again to the image forming unit and, with image forming now having been completed on both sides of the paper, the paper is now guided by the first guide clutch 221 into the paper-ejecting path 202 to the paper-ejecting unit to be discharged outside of the main body 200.

In the image forming apparatus A, the conveying of a one-side printed paper or a both-sides printed paper can be sensed by one or more sensors (not shown), in addition to the first sensor 268 and the second sensor 269, provided on the paper-traveling path to provide information on the printing operation to the controller 206.

Also, in the image forming apparatus A, the second clutch 266 and the conveyor roller 265 of the lower cartridge 260 are controlled through the controller 206 according to signals from the first sensor 268 and the second sensor 269. In this regard, when the first sensor 268 detects paper introduced into the return-paper inlet 262, the second guide clutch 266 and the conveyor roller 265 are controlled to be pivoted and rotated counterclockwise. Therefore, the paper introduced into the return-paper inlet 262 is conveyed to the accommodation path 263. On the other hand, when the second sensor 269 detects the paper conveyed into the accommodation path 263, the second guide clutch 266 and the conveyor roller 265 are controlled to be pivoted and rotated clockwise. Thus, the paper accommodated in the accommodation path 263 is conveyed into the reversing path 267, to reverse a position of the sides of the paper, and is then introduced into the paper-feeding path 201.

Further, in the image forming apparatus A, according to aspects of the invention, pivoting or rotating elements provided in the lower cartridge 260, for example, the second guide clutch 266, the conveyor rollers 264 and 265, or the like, can be configured to be driven by a driver unit (not shown) provided in the main body 200 through a power transferring mechanism ns such as a gear or a belt. Alternatively, a separate driver unit and power transferring mechanism can be provided inside the lower cartridge 260, or in both the lower cartridge 260 and in the main body 200.

Also, in the embodiment of the image forming apparatus A, for a both-sides printing operation, the return-paper inlet 262, the sensors 268 and 269, the second guide clutch 266, the accommodation path 263, the conveyor roller 265, the reversing path 267, and the like are illustrated as being provided in the lower cartridge 260 as the detachably mounted paper-feeder cartridge including the above described elements providing the both-sides printing function in the image forming apparatus A according to aspects of the invention, but, in other aspects of the invention, the image forming apparatus according to the aspects of the invention are not limited to the image forming apparatus as illustrated in FIGS. 2 and 3. For example, these elements alternatively can be provided in the upper cartridge 250 of the image forming apparatus A to perform both-sides printing, and both such configurations, among others, are included in the scope of the invention.

As described above, according to aspects of the invention an image forming apparatus is provided, in which a paper-feeder cartridge to be mounted in the apparatus can be used to perform both-sides printing, without providing separate components for the both-sides printing. Thus, the apparatus can be structured in a simplified manner, thereby improving the space efficiency. In addition, a conventional one-side printing image forming apparatus can be adapted, according to aspects of the invention, to provide an image forming apparatus including a both-sides printing function according to the invention, thereby providing advantages in terms of cost reduction.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. An image forming apparatus, comprising:
a main body, including:
a feeding path to supply a medium to form an image on the medium,
an image forming unit to form an image on a side of the medium supplied through the feeding path,
an ejecting unit to eject to outside of the main body the medium passed through the image forming unit, when image forming is completed on the medium, and
a first guide clutch provided adjacent to an exit side of the image forming unit to selectively convert a path of the medium, when the medium has passed through the image forming unit, wherein the first guide clutch selectively converts a path of the medium to an ejecting path of the main body to the ejecting unit when image forming has been completed on the medium, and wherein the first guide clutch selectively converts a path of the medium to a return-path of the main body when image forming is to be performed on the other side of the medium and has not been completed; and
a feeder cartridge detachably mounted on the main body to selectively supply the medium to form an image on the medium, including:
a return inlet through which the medium conveyed through the return-path is introduced to the feeder cartridge,
a reversing unit to reverse a position of the sides of the medium introduced through the return inlet, and
a return exit through which the medium from the reversing unit is conveyed, with the position of the sides of the medium reversed, to the feeding path of the main body to return the medium to the image forming unit to form an image on the other side of the medium on which image forming is to be performed and has not been completed.

2. The apparatus according to claim 1, wherein the reversing unit comprises:
an accommodation path to accommodate the medium introduced through the return inlet;
a reversing path, one end of which is connected with the accommodation path and the other end of which is connected to the return exit; and
a conveyor roller to convey the medium accommodated in the accommodation path to the reversing path to reverse a position of the sides of the medium.

3. The apparatus according to claim 2, wherein the reversing unit further comprises:
a first sensor to sense the medium being introduced into the return inlet;
a second sensor to sense the medium accommodated in the accommodation path; and
a second guide clutch to selectively block a position between the accommodation path and the reversing path based on a signal from the first sensor and to selectively block a position between the return inlet and the accommodation path based on a signal from the second sensor.

4. The apparatus according to claim 3, further comprising:
an upper cartridge and a lower cartridge to be detachably mounted in the image forming apparatus, the upper cartridge and the lower cartridge to selectively supply the medium to form an image on at least one side of the medium, with the upper cartridge positioned over the lower cartridge when detachably mounted in the image forming apparatus, and
wherein the feeder cartridge comprises the lower cartridge.

5. The apparatus according to claim 4, further comprising:
a feeding unit to feed the medium to the feeding path to form an image on the medium.

6. The apparatus according to claim 2, further comprising:
an upper cartridge and a lower cartridge to be detachably mounted in the image forming apparatus, the upper cartridge and the lower cartridge to selectively supply the medium to form an image on at least one side of the medium, with the upper cartridge positioned over the lower cartridge when detachably mounted in the image forming apparatus, and
wherein the feeder cartridge comprises the lower cartridge.

7. The apparatus according to claim 6, further comprising:
a feeding unit to feed the medium to the feeding path to form an image on the medium.

8. The apparatus according to claim 2, further comprising:
a feeding unit to feed the medium to the feeding path to form an image on the medium.

9. The apparatus according to claim 2, wherein the reversing unit further comprises:
a second guide clutch to selectively block a position between the accommodation path and the reversing path to guide the medium into the accommodation path and to selectively block a position between the return inlet and the accommodation path to guide the medium into the reversing path.

10. The apparatus according to claim 9, wherein the reversing unit further comprises:
a first sensor to sense the medium being introduced into the return inlet; and
a second sensor to sense the medium accommodated in the accommodation path,
wherein the second guide clutch selectively blocks the position between the accommodation path and the reversing path based on a signal from the first sensor and selectively blocks the position between the return inlet and the accommodation path based on a signal from the second sensor.

11. The apparatus according to claim 10, further comprising:
an upper cartridge and a lower cartridge to be detachably mounted in the image forming apparatus, the upper cartridge and the lower cartridge to selectively supply the medium to form an image on at least one side of the medium, with the upper cartridge positioned over the lower cartridge when detachably mounted in the image forming apparatus, and
wherein the feeder cartridge comprises the lower cartridge.

12. The apparatus according to claim 10, further comprising:
a feeding unit to feed the medium to the feeding path to form an image on the medium.

13. The apparatus according to claim 1, further comprising:
an upper cartridge and a lower cartridge to be detachably mounted in the image forming apparatus, the upper cartridge and the lower cartridge to selectively supply the medium to form an image on at least one side of the medium, with the upper cartridge positioned over the lower cartridge when detachably mounted in the image forming apparatus, and
wherein the feeder cartridge comprises the lower cartridge.

14. The apparatus according to claim 13, further comprising:
a feeding unit to feed the medium to the feeding path to form an image on the medium.

15. The apparatus according to claim 1, further comprising:
a feeding unit to feed the medium to the feeding path to form an image on the medium.

16. A method of forming an image in an image forming apparatus, comprising:
supplying a medium to a feeding path;
conveying the medium through the feeding path to an image forming unit;
forming, by the image forming unit, an image on a side of the medium supplied through the feeding path;
selectively converting a path of the medium, when the medium has passed through the image forming unit, to an ejecting path to eject the medium from the image forming apparatus, when image forming has been completed on the medium;
selectively converting a path of the medium, when the medium has passed through the image forming unit, to a return-path, when image forming is to be performed on the other side of the medium and has not been completed;
conveying the medium through the return-path, when the path of the medium has been selectively converted to the return-path, to a reversing unit in a feeder cartridge detachably mounted on the image forming apparatus;
reversing, by the reversing unit, when the medium has been conveyed to the reversing unit, a position of the sides of the medium; and
conveying the medium from the reversing unit, with the position of the sides of the medium reversed, to the feeding path to return the medium to the image forming unit to form an image on the other side of the medium, when image forming is be performed on the other side of the medium and has not been completed.

17. The method of claim 16, wherein reversing, by the reversing unit, a position of the sides of the medium further comprises:
accommodating the medium, returned through the return-path, in an accommodation path of the reversing unit; and
conveying the medium accommodated in the accommodation path to a reversing path of the reversing unit to reverse the position of the sides of the medium.

18. The method of claim 17, wherein reversing, by the reversing unit, a position of the sides of the medium further comprises:
sensing by a first sensor the medium being introduced into the reversing unit;
sensing by a second sensor the medium accommodated in the accommodation path;
selectively blocking a position between the accommodation path and the reversing path, based on a signal from the first sensor, to guide the medium from the return-path to the accommodation path; and
selectively blocking a position between the return-path and the accommodation path, based on a signal from the second sensor, to guide the medium from the accommodation path to the reversing path.

19. The method of claim 16, further comprising:
detachably mounting an upper cartridge and a lower cartridge in the image forming apparatus, the upper cartridge and the lower cartridge to selectively supply the medium to form an image on at least one side of the medium, with the upper cartridge positioned over the lower cartridge when detachably mounted in the image forming apparatus, and
wherein the feeder cartridge comprises the lower cartridge.
